(19) United States
(12) Patent Application Publication
(10) Pub. No.: US 2023/0163538 A1
(43) Pub. Date: May 25, 2023

(54) CONNECTOR DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Yutaka KOBAYASHI, Mie (JP); Yorikazu MURABAYASHI, Mie (JP)

(21) Appl. No.: 17/918,531

(22) PCT Filed: Mar. 16, 2021
(86) PCT No.: PCT/JP2021/010473

§ 371 Date: Oct. 12, 2022

(30) Foreign Application Priority Data
Apr. 23, 2020 (JP) 2020-076459

(51) Int. Cl. H01R 24/54; H01R 24/44; H01R 12/57; H01R 13/405

(52) U.S. Cl. CPC H01R 24/54; H01R 24/44; H01R 12/57; H01R 13/405; H01R 2103/00

(57) ABSTRACT

It is aimed to improve transmission characteristics. A connector device is provided with a first terminal including a first inner conductor and to be mounted on a first circuit board, and an elongated movable terminal including a movable-side inner conductor and to be arranged between the first terminal and a second terminal. The first inner conductor includes a mounting portion to be connected to the first circuit board and a first connecting portion extending from the mounting portion toward the movable terminal. The movable-side inner conductor includes a movable-side connecting portion to be connected to the first connecting portion while being fit to the first connecting portion in a length direction of the movable terminal and a shaft-like body portion extending from the movable-side connecting portion toward the mating terminal. An outer diameter of the body portion and an outer diameter of the mounting portion are set equal.

### TECHNICAL FIELD

The present disclosure relates to a connector device.

### BACKGROUND

Patent Document 1 discloses a connector device configured to connect a first connector and a second connector facing each other via an adapter. The adapter is relatively rockably connected to the first and second connectors. The first and second connectors can be respectively mounted on a first circuit board and a second circuit board. When the first and second circuit boards are shifted in position in a direction intersecting a facing direction, the adapter is inclined to accommodate position shifts of the first and second circuit boards.

### PRIOR ART DOCUMENT

### Patent Document

Patent Document 1: U.S. Pat. No. 4,925,403

### SUMMARY OF THE INVENTION

### Problems to be Solved

The first connector includes a first inner conductor to be mounted on the first circuit board and the second connector includes a second inner conductor to be mounted on the second circuit board. The adapter includes a movable-side inner conductor, and both end parts of the movable-side inner conductor are connected to the first and second inner conductors while being externally fit to the first and second inner conductors. Since the movable-side inner conductor is shaped to surround the first and second inner conductors, an outer diameter of the movable-side inner conductor is larger than those of the first and second inner conductors. A variation in the outer diameters of these inner conductors degrades transmission characteristics.

A connector device of the present disclosure was completed on the basis of the above situation and the present disclosure aims to improve transmission characteristics.

### Means to Solve the Problem

The present disclosure is directed to a connector device with a mounting terminal including a mounting-side inner conductor, the mounting terminal being mounted on a circuit board, and an elongated movable terminal including a movable-side inner conductor, the movable terminal being arranged between the mounting terminal and a mating terminal, the mounting-side inner conductor including a mounting portion to be connected to the circuit board and a mounting-side connecting portion extending from the mounting portion toward the movable terminal, the movable-side inner conductor including a movable-side connecting portion to be connected to the mounting-side connecting portion while being fit to the mounting-side connecting portion in a length direction of the movable terminal and a shaft-like body portion extending from the movable-side connecting portion toward the mating terminal, and an outer diameter of the body portion and an outer diameter of the mounting portion being set equal.

### Effect of the Invention

According to the present disclosure, it is possible to improve transmission characteristics.

### BRIEF DESCRIPTION OF THE DRAWINGS

FIG. 1 is a perspective view of a connector device of one embodiment.

FIG. 2 is an exploded perspective view of the connector device.

FIG. 3 is a front view in section of the connector device.

FIG. 4 is a side view in section of the connector device.

FIG. 5 is a perspective view of a movable terminal.

FIG. 6 is a perspective view of a first terminal.

FIG. 7 is an exploded perspective view of the first terminal.

FIG. 8 is a partial enlarged front view in section showing a connection structure of the first terminal and the movable terminal.

### DETAILED DESCRIPTION TO EXECUTE THE INVENTION

### Description of Embodiments of Present Disclosure

First, embodiments of the present disclosure are listed and described.

(1) The connector device of the present disclosure is provided with a mounting terminal including a mounting-side inner conductor, the mounting terminal being mounted on a circuit board, and an elongated movable terminal including a movable-side inner conductor, the movable terminal being arranged between the mounting terminal and a mating terminal, the mounting-side inner conductor including a mounting portion to be connected to the circuit board and a mounting-side connecting portion extending from the mounting portion toward the movable terminal, the movable-side inner conductor including a movable-side connecting portion to be connected to the mounting-side connecting portion while being fit to the mounting-side connecting portion in a length direction of the movable terminal and a shaft-like body portion extending from the movable-side connecting portion toward the mating terminal, and an outer diameter of the body portion and an outer diameter of the mounting portion being set equal.

To improve transmission characteristics in a transmission path from the elongated movable terminal to the circuit board via the mounting terminal, an impedance of the mounting terminal and that of the movable terminal are desirably matched. However, in a connected part in which the movable-side connecting portion and the mounting-side connecting portion are fit in the length direction of the movable terminal, an outer diameter becomes larger than in other parts. Thus, there is a concern for impedance mismatching. Accordingly, in the connector device of the present disclosure, the outer diameter of the mounting portion near the circuit board is set equal to the outer diameter of the shaft-like body portion of the movable terminal. According to this dimensioning, an impedance near the circuit board can be matched with an impedance of the transmission path constituted by the elongated movable terminal. In this way, the transmission characteristics can be improved on the whole in the transmission path from the elongated movable terminal to the circuit board via the mounting-side terminal.

(2) Preferably, a length of the body portion is larger than that of the mounting-side inner conductor. According to this configuration, a length of the connected part of the movable-side connecting portion and the mounting-side connecting portion, i.e. a length of a region of impedance mismatching, is shorter than the length of the body portion, wherefore the transmission characteristics can be improved on the whole.

(3) Preferably, the movable-side connecting portion is connected while being accommodated in the mounting-side connecting portion, and an outer diameter of the movable-side connecting portion is set smaller than that of the body portion. According to this configuration, since the outer diameter of the mounting-side connecting portion can be suppressed to be small and a difference between an impedance in the connected part of the movable-side connecting portion and the mounting-side connecting portion and an impedance in the body portion and the mounting portion can be reduced, the transmission characteristics can be improved on the whole.

(4) Preferably, the mounting portion is fixed to the circuit board by solder, the mounting terminal includes a tubular mounting-side dielectric for accommodating the mounting-side inner conductor, and a clearance is provided between an end part of an inner peripheral surface of the mounting-side dielectric on the side of the circuit board and an end part of an outer peripheral surface of the mounting portion on the side of the circuit board. According to this configuration, the solder in a molten state can be prevented from intruding into a gap between the inner peripheral surface of the mounting-side dielectric and the outer peripheral surface of the mounting portion by a capillary phenomenon.

(5) Preferably, the movable terminal includes a movable-side dielectric surrounding the movable-side inner conductor and a movable-side outer conductor surrounding the movable-side dielectric, and an end part of the movable-side dielectric on the side of the mounting terminal projects further toward the mounting-side connecting portion than an end part of the movable-side outer conductor. According to this configuration, the interference of the movable-side outer conductor with the mounting-side connecting portion can be prevented when the movable terminal is assembled with the mounting terminal.

### Details of Embodiment of Present Disclosure

### Embodiment

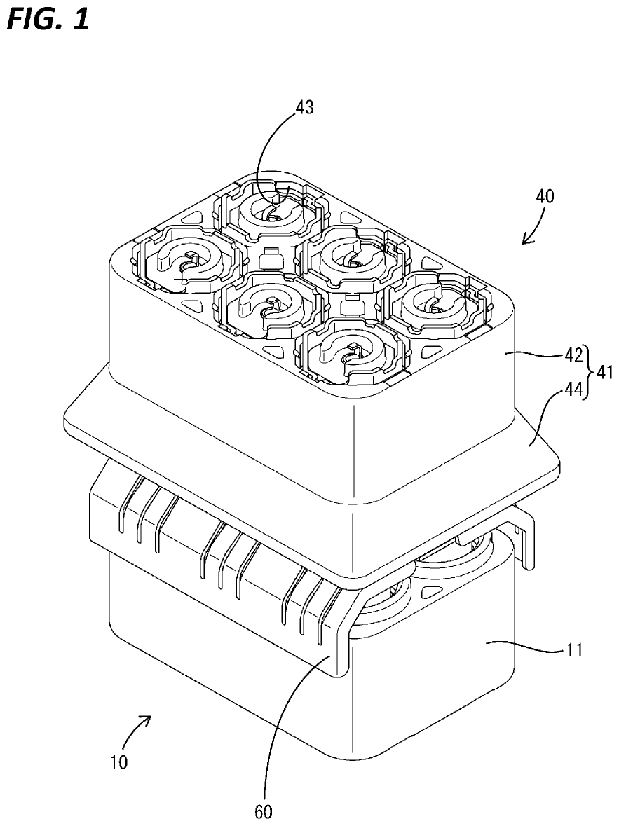

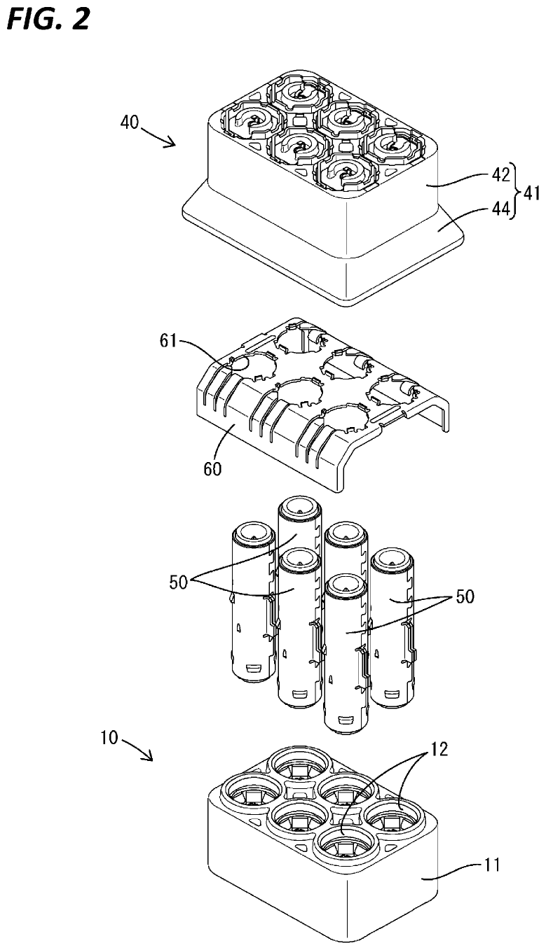

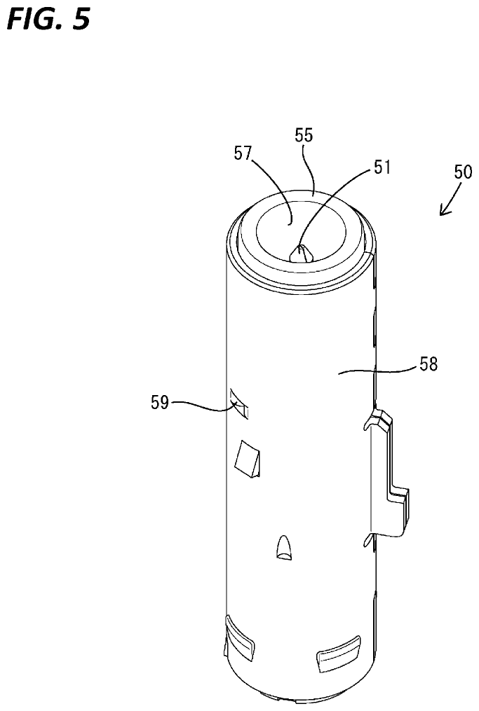

One specific embodiment of a connector device of the present disclosure is described below with reference to FIGS. 1 to 8. Note that the present invention is not limited to these illustrations and is intended to be represented by claims and include all changes in the scope of claims and in the meaning and scope of equivalents. In this embodiment, an oblique right lower side in FIGS. 1 and 2 is defined as a front side concerning a front-rear direction. Upper and lower sides shown in FIGS. 1 to 8 are directly defined as upper and lower sides concerning a vertical direction. An oblique left lower side in FIGS. 1 and 2 is defined as a left side concerning a lateral direction.

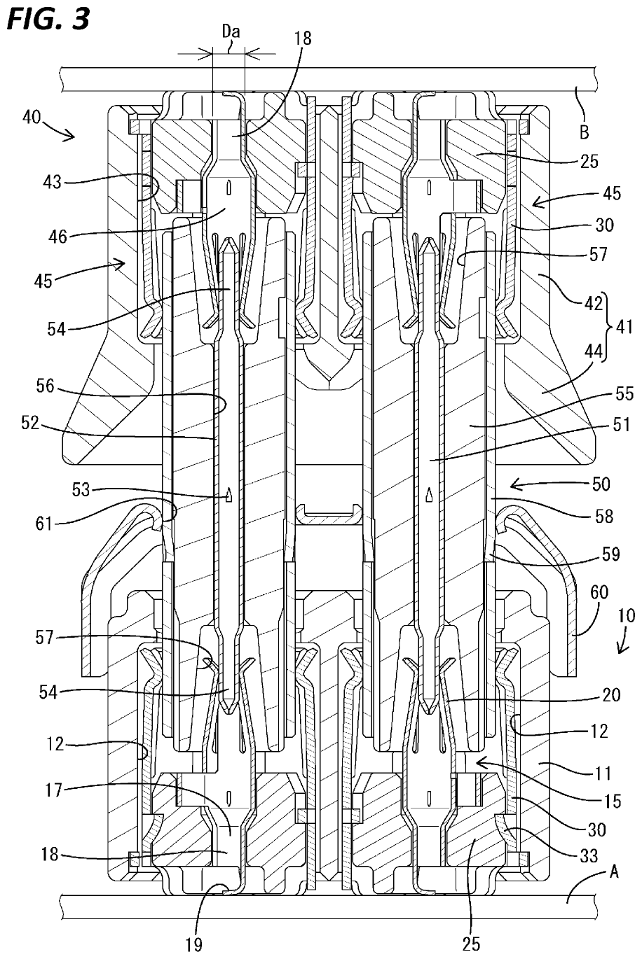

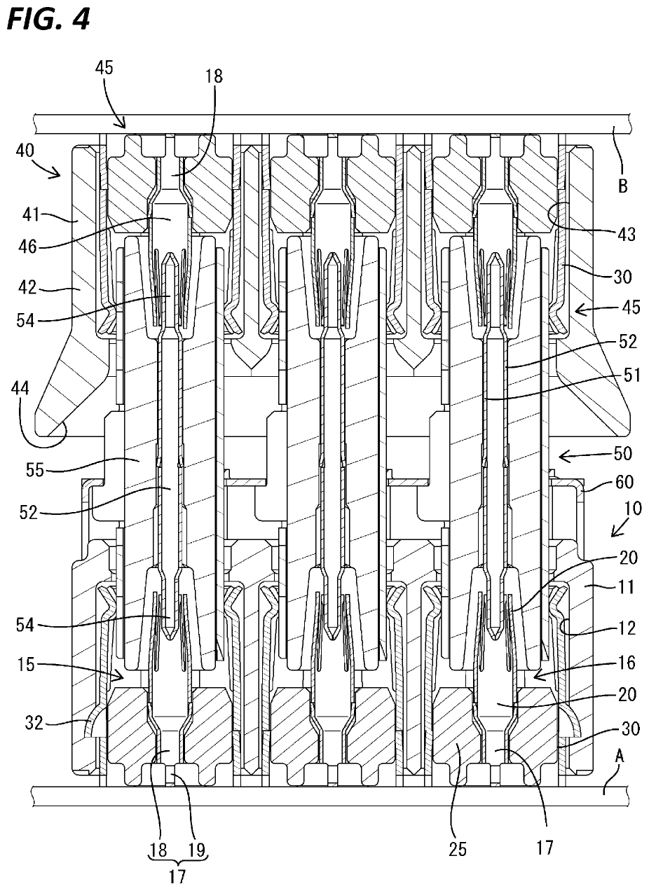

The connector device of this embodiment includes, as shown in FIGS. 1 and 2, a first connector 10, a second connector 40 and movable terminals 50. As shown in FIGS. 3 and 4, the first connector 10 is mounted on a first circuit board A, and the second connector 40 is mounted on a second circuit board B.

The first circuit board A is, for example, provided in an ECU (not shown) mounted in a roof of an automotive vehicle, and horizontally arranged with a mounting surface facing up, i.e. facing toward the side of an antenna (not shown). The second circuit board B is, for example, provided in the antenna (not shown) to be mounted in the roof (not shown) of the automotive vehicle. The second circuit board B is horizontally arranged with a mounting surface facing down, i.e. facing toward a vehicle interior side. The first and second circuit boards A, B are arranged in such a positional relationship that the mounting surfaces of the both are facing in parallel to each other.

If the first and second circuit boards A, B are brought closer, the both circuit boards A, B are connected via the first connector 10, the second connector 40 and the movable terminals 50. Since the first and second circuit boards A, B are connected without via a wiring harness, high-speed communication is possible between the first and second circuit boards A, B. Since assembly tolerances of the roof and the antenna are relatively large in an antenna mounted part in the roof of the automotive vehicle, position shifts possibly occur between the first and second circuit boards A, B in a horizontal direction intersecting a connecting direction of the both connectors 10, 40. The connector device of this embodiment is configured such that the both connectors 10, 40 are connected while the position shifts of the both circuit boards A, B are accommodated by rocking movements of the movable terminals 50.

As shown in FIGS. 2 and 3, the first connector 10 includes a first housing 11 and a plurality of first terminals 15. With the first connector 10 mounted on the first circuit board A, the lower surface of the first housing 11 is fixed to the first circuit board A and lower end parts of the plurality of first terminals 15 are connected to a printed circuit (not shown) of the first circuit board A. The first terminals 15 function as mounting terminals to be mounted on the first circuit board A.

The first housing 11 is a single component made of synthetic resin and having a rectangular parallelepiped shape. The first housing 11 is formed with as many first terminal accommodation chambers 12 as the first terminals 15. The first terminal accommodation chambers 12 vertically penetrate through the first housing 11. In a plan view of the first housing 11, the first terminal accommodation chambers 12 are circular. The plurality of first terminal accommodation chambers 12 are divided into two left and right rows, and three chambers are arranged to be aligned in a row in the front-rear direction in each row.

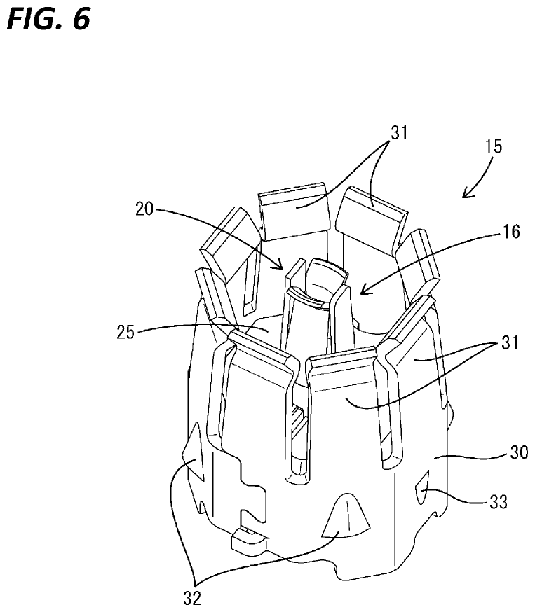

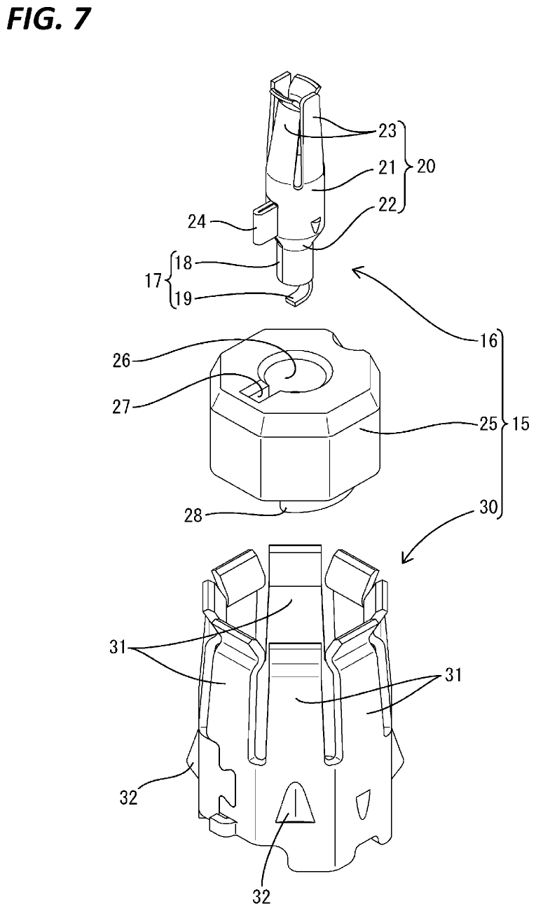

The plurality of first terminals 15 are individually accommodated in the plurality of first terminal accommodation chambers 12. As shown in FIGS. 6 and 7, the first terminal 15 includes a first inner conductor 16, a first dielectric 25 and a first outer conductor 30. The first inner conductor 16 is a single component having a tubular shape with an axis oriented in the vertical direction orthogonal to the first circuit board A and including a mounting portion 17 and a first connecting portion 20. The first inner conductor 16 functions as a mounting-side inner conductor to be mounted on the first circuit board A. The mounting portion 17 includes a hollow cylindrical portion 18 and a leg portion 19 projecting toward the first circuit board A from the lower end edge of the hollow cylindrical portion 18. The leg portion 19 is in the form of a plate bent into an L shape.

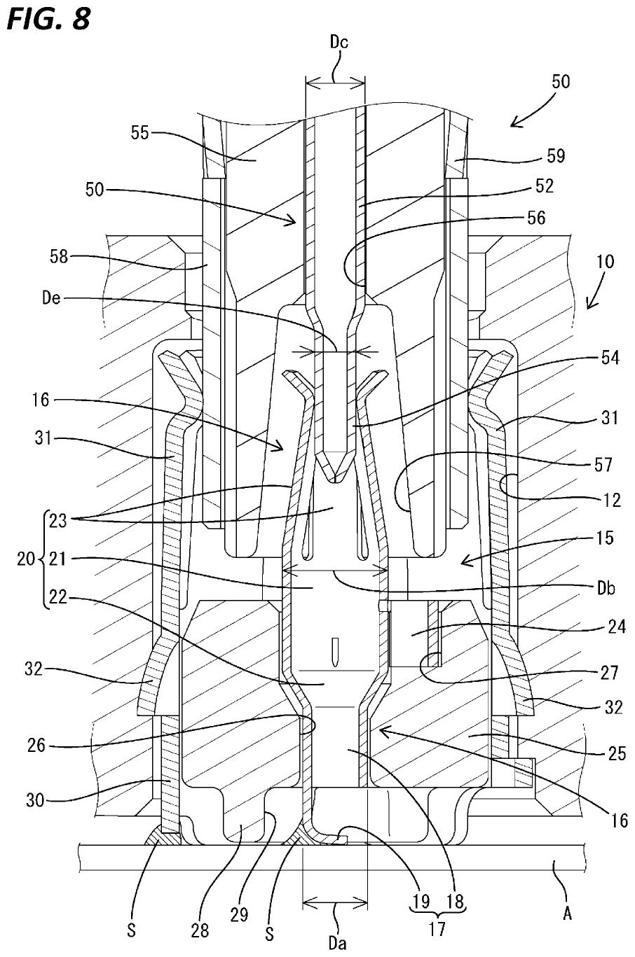

The first connecting portion 20 is a part functioning as a mounting-side connecting portion to be connected to the movable terminal. The first connecting portion 20 includes a hollow cylindrical supporting portion 21, a tapered portion 22 having a truncated conical shape and linking the lower end edge of the supporting portion 21 and the upper end edge of the hollow cylindrical portion 18, and a plurality of resilient contact pieces 23 cantilevered upward (toward the second circuit board B) from the upper end edge of the supporting portion 21. As shown in FIG. 8, an outer diameter Db of the supporting portion 21 is larger than an outer diameter Da of the hollow cylindrical portion 18. The plurality of resilient contact pieces 23 are point-symmetrically arranged at intervals in a circumferential direction. A positioning protrusion 24 is formed on the outer peripheral surface of the supporting portion 21.

The first dielectric 25 is a member made of synthetic resin and having a hollow cylindrical shape with an axis oriented in the vertical direction. The first dielectric 25 functions as a mounting-side dielectric surrounding the mounting-side inner conductor. The supporting portion 21, the tapered portion 22 and the hollow cylindrical portion 18 of the first inner conductor 16 are accommodated in a center hole 26 of the first dielectric 25, and the positioning protrusion 24 is press-fit into a groove portion 27 of the center hole 26. The resilient contact pieces 23 of the first inner conductor 16 project upward from the upper end surface of the first dielectric 25. An arcuate projection 28 having an arched shape concentric with the first dielectric 25 is formed on the lower end surface (surface facing the first circuit board A) of the first dielectric 25. The arcuate projection 28 surrounds the leg portion 19 projecting from the lower end surface of the first dielectric 25. A clearance 29 is secured between the leg portion 19 and the inner peripheral surface of the arcuate projection 28.

The first outer conductor 30 is a single component made of metal and in the form of an angular tube having a polygonal shape. The first outer conductor 30 functions as a mounting-side outer conductor surrounding the mounting-side dielectric (first dielectric 25). A plurality of resilient arms 31 divided in the circumferential direction are formed in an upper end side region of the first outer conductor 30. A projection-like press-fit portion 32 is formed on the outer peripheral surface of the first outer conductor 30. A projecting portion 33 is formed on the inner peripheral surface of the first outer conductor 30. The first outer conductor 30 surrounds the first dielectric 25. As shown in FIG. 3, the projecting portion 33 bites into an outer peripheral part of the first dielectric 25, whereby the first outer conductor 30 and the first dielectric 25 are held in an assembled state. By assembling the first inner conductor 16 and the first dielectric 25 and assembling the first dielectric 25 and the first outer conductor 30, the first terminal 15 is configured.

As shown in FIG. 8, with the first terminal 15 accommodated in the first terminal accommodation chamber 12, the press-fit portion 32 is press-fit into an inner peripheral part of the first terminal accommodation chamber 12, whereby the first terminal 15 is held in a state assembled with the first housing 11. The first dielectric 25 is arranged in a lower end part of the first terminal accommodation chamber 12 and the resilient arms 31 project upward along the inner peripheral surface of the first terminal accommodation chamber 12. The plurality of resilient contact pieces 23 projecting upward from the upper end surface of the first dielectric 25 are surrounded by the plurality of resilient arms 31.

By accommodating the first terminals 15 into the first terminal accommodation chambers 12, the first connector 10 is configured. The first connector 10 is mounted on the first circuit board A. In mounting the first connector 10, the L-shaped leg portions 19 formed in the mounting portions 17 of the first inner conductors 16 are conductively welded to the mounting surface of the first circuit board A by solder S. The lower end parts of the first outer conductors 30 are also fixed to the mounting surface of the first circuit board A by the solder S. Further, the arcuate projections 28 projecting from the lower end surfaces of the first dielectrics 25 come into contact with the mounting surface of the first circuit board A, but the clearances 29 are secured over the entire peripheries of the leg portions 19 between the inner peripheral surfaces of the arcuate projections 28 and the leg portions 19. Therefore, there is no possibility that the solder S in contact with the leg portions 19 in a molten state intrudes into gaps between the arcuate projections 28 and the leg portions 19 by a capillary phenomenon.

As shown in FIGS. 3 and 4, the second connector 40 includes a second housing 41 and as many second terminals 45 as the first terminals 15. With the second connector 40 mounted on the second circuit board B, the upper surface of the second housing 41 is fixed to the mounting surface of the second circuit board B and upper end parts of a plurality of the second terminals 45 are connected to a printed circuit (not shown) of the second circuit board B. The second housing 41 is a single component made of synthetic resin and including a terminal holding portion 42 having a rectangular parallelepiped shape and a rectangular guiding portion 44. The terminal holding portion 42 is formed with a plurality of (six in this embodiment) second terminal accommodation chambers 43 vertically penetrating through the terminal holding portion 42. The second terminal accommodation chambers 43 are obtained by vertically inverting the first terminal accommodation chambers 12.

The plurality of second terminals 45 are individually accommodated in the plurality of second terminal accommodation chambers 43. The second terminal 45 is the same component as the first terminal 15 and mounted in the second terminal accommodation chamber 43 in an orientation vertically inverted from that of the first terminal 15. The guiding portion 44 projects obliquely downward in a skirt-like manner from the outer peripheral edge of the lower end of the terminal holding portion 42. The guiding portion 44 is inclined to become wider toward the bottom with respect to the connecting direction of the both connectors 10, 40. An internal space of the guiding portion 44 communicates with the plurality of second terminal accommodation chambers 43 and is open downward of the second housing 41. The second connector 40 is mounted on the mounting surface of the second circuit board B in a manner similar to a mounting mode of the first connector 10 on the first circuit board A.

As shown in FIGS. 2 to 5, the movable terminal 50 has an elongated shape with an axis oriented in the vertical direction (facing direction of the first and second circuit boards A, B) as a whole. Both end parts in an axial direction of the movable terminal 50 have such symmetry as to have the same shape when the movable terminal 50 is inverted. As shown in FIGS. 3 and 4, the movable terminal 50 is a member configured by assembling a movable-side inner conductor 51, a movable-side dielectric 55 and a movable-side outer conductor 58.

The movable-side inner conductor 51 is a metal member having a tubular shape elongated in the axial direction of the movable terminal 50. The movable-side inner conductor 51 is a single component including a hollow cylindrical body portion 52 and a pair of vertically symmetrical movable-side connecting portions 54. As shown in FIG. 8, an outer diameter Dc of the body portion 52 is equal to the outer diameter Da of the hollow cylindrical portion 18 of the first inner conductor 16. A retaining projection 53 is formed on the outer peripheral surface of the body portion 52. The upper movable-side connecting portion 54 projects upward coaxially with the body portion 52 from the upper end of the body portion 52, and the lower movable-side connecting portion 54 projects downward coaxially with the body portion 52 from the lower end of the body portion 52. An outer diameter De of the movable-side connecting portion 54 is smaller than the outer diameter Dc of the body portion 52 and the outer diameter Da of the hollow cylindrical portion 18. A length in the axial direction of the movable-side connecting portion 54 is shorter than that of the body portion 52.

The movable-side dielectric 55 has a hollow cylindrical shape coaxial with the movable-side inner conductor 51. The movable-side inner conductor 51 is coaxially accommodated in an insertion hole 56 of the movable-side dielectric 55. The retaining projection 53 bites into an inner peripheral part of the insertion hole 56, whereby the movable-side inner conductor 51 and the movable-side dielectric 55 are integrally assembled. Circular accommodation recesses 57 are formed in both end parts in the axial direction of the movable-side dielectric 55 by coaxially recessing both upper and lower end surfaces of the movable-side dielectric 55. The accommodation recesses 57 communicate with the insertion hole 56. The movable-side connecting portions 54 are accommodated into the accommodation recesses 57.

The movable-side outer conductor 58 has a hollow cylindrical shape as a whole. The movable-side outer conductor 58 is formed with a locking piece 59 cut and raised to project toward an inner peripheral side. The movable-side outer conductor 58 coaxially surrounds the movable-side dielectric 55. The locking piece 59 bites into an outer peripheral part of the movable-side dielectric 55, whereby the movable-side outer conductor 58 and the movable-side dielectric 55 are integrated. A lower end part of the movable-side dielectric 55 projects further downward than the lower end of the movable-side outer conductor 58, and an upper end part of the movable-side dielectric 55 projects further upward than the upper end of the movable-side outer conductor 58. The movable terminal 50 is configured by assembling the movable-side inner conductor 51, the movable-side dielectric 55 and the movable-side outer conductor 58.

A lower end part (one end part) of the movable terminal 50 is inserted into the first terminal accommodation chamber 12 and mounted in the first terminal 15. At this time, since the lower end part of the movable-side dielectric 55 projects further downward than the lower end of the movable-side outer conductor 58, it is possible to prevent the interference of the movable-side outer conductor 58 with the upper surface of the first housing 11 and the interference of the movable-side outer conductor 58 with the upper end part of the first inner conductor 16.

With the movable terminal 50 mounted in the first terminal 15, the resilient arms 31 of the first outer conductor 30 resiliently contact the outer peripheral surface of the movable-side outer conductor 58. In the accommodation recess 57 of the movable terminal 50, the resilient contact pieces 23 of the first inner conductor 16 surround the movable-side inner conductor 51 and resiliently contact the outer peripheral surface of the movable-side inner conductor 51. The movable terminal 50 is rockable in the front-rear direction and lateral direction with the first terminal 15 as a fulcrum.

The movable terminal 50 mounted in the first terminal 15 projects further upward than the upper end surface of the first housing 11. The upper end part of the movable terminal 50 is connected to the second terminal 45, which is a mating terminal. Since one movable terminal 50 is supported in contact with only one first terminal 15, there is a concern that the plurality of movable terminals 50 individually rock in directions different from the other movable terminals 15. As a countermeasure against this, the plurality of movable terminals 50 are made integrally rockable by being passed through holding holes 61 of an alignment member 60 as shown in FIG. 3.

After the movable terminals 50 are mounted into the first connector 10, the first and second circuit boards A, B are brought closer to connect the upper end parts of the movable terminals 50 to the second connector 40. The movable terminals 50 and the second connector 40 are connected in a manner similar to the connection of the movable terminals 50 and the first connector 10. Transmission paths are configured by the first terminals 15, the movable terminals 50 and the second terminals 45 between the first and second circuit boards A, B. To improve transmission characteristics of these transmission paths, overall impedance matching of the transmission paths is necessary.

In the connector device of this embodiment, the outer diameter Dc of the body portion 52 of the movable-side inner conductor 51, the outer diameter Da of the hollow cylindrical portion 18 of the first inner conductor 16 and an outer diameter Da (see FIG. 3) of a hollow cylindrical portion 18 of a second inner conductor 46 are set equal as shown in FIGS. 3 and 8 as a means for enhancing impedance matching. As shown in FIGS. 3 and 4, a length in the axial direction of the body portion 52 accounts for ⅓ of a length of the transmission path between the both circuit boards A and B. Further, the hollow cylindrical portion 18 of the first inner conductor 16 is shorter in axial length than the body portion 52, but is arranged at a position closer to the first circuit board A than the body portion 52. The hollow cylindrical portion 18 of the second inner conductor 46 is shorter in axial length than the body portion 52, but is arranged at a position closer to the second circuit board B than the body portion 52. Therefore, overall impedance matching of the transmission paths between the both circuit boards A and B is high and the transmission characteristics are high on the whole.

The connector device of this embodiment includes the first terminals 15 and the movable terminals 50. The first terminal 15 includes the first inner conductor 16 and is mounted on the first circuit board A. The movable terminal 50 is an elongated member including the movable-side inner conductor 51. The movable terminal 50 is arranged between the first terminal 15 serving as the mounting terminal and the second terminal 45 serving as the mating terminal. The first inner conductor 16 includes the mounting portion 17 to be connected to the first circuit board A and the first connecting portion 20 extending from the mounting portion 17 toward the movable terminal 50. The movable-side inner conductor 51 includes the movable-side connecting portions 54 and the body portion 52. The movable-side connecting portion 54 is fit into the first connecting portion 20 in a length direction of the movable terminal 50 and connected with peripheral surfaces radially facing each other. The body portion 52 is shaft-like and elongated from the movable-side connecting portion 54 toward the second terminal 45. The outer diameter Dc of the body portion 52 and the outer diameter Da of the hollow cylindrical portion 18 of the mounting portion 17 are set equal.

In the transmission path from the elongated movable terminal 50 to the first circuit board A via the first terminal 15, an impedance of the first terminal 15 and that of the movable terminal 50 are desirably matched to improve transmission characteristics. However, in a connected part in which the movable-side connecting portion 54 is fit in the first connecting portion 20, the movable-side connecting portion 54 and the first connecting portion 20 radially overlap and an outer diameter becomes larger than in other parts. Thus, there is a concern for impedance mismatching.

Accordingly, in this embodiment, the outer diameter Da of the mounting portion 17 (hollow cylindrical portion 18) near the first circuit board A is set equal to the outer diameter Dc of the shaft-like body portion 52. According to this dimensioning, an impedance near the first circuit board A can be matched with an impedance of the transmission path constituted by the elongated movable terminal 50. Thus, the transmission characteristics can be improved on the whole in the transmission path from the elongated movable terminal 50 to the first circuit board A via the first terminal 15.

The length in the axial direction of the body portion 52 is set longer than that of the first inner conductor 16. Most of the transmission path from the movable terminal 50 to the first circuit board A is constituted by the body portion 52. Since a length of the connected part of the movable-side connecting portion 54 and the first connecting portion 20, i.e. a length of a region of impedance mismatching, is shorter than the length in the axial direction of the body portion 52 and the entire length in the axial direction of the first inner conductor 16, the degradation of the transmission characteristics is suppressed.

The movable-side connecting portion 54 is connected while being accommodated in the first connecting portion 20. The outer diameter De of the movable-side connecting portion 54 is set smaller than the outer diameter Dc of the body portion 52. According to this configuration, since the outer diameter of the first connecting portion 20 can be suppressed to be small and a difference between an impedance in the connected part of the movable-side connecting portion 54 and the first connecting portion 20 and an impedance in the body portion 52 and the mounting portion 17 can be reduced, the transmission characteristics can be improved on the whole.

The mounting portion 17 is fixed to the first circuit board A by the solder S. The first terminal 15 includes the tubular first dielectric 25 for accommodating the first inner conductor 16. The arcuate projection 28 for surrounding an end part of the mounting portion 17 on the side of the first circuit board A is formed on an end part of the inner peripheral surface of the first dielectric 25 on the side of the first circuit board A. The clearance 29 is provided between the inner peripheral surface of the arcuate projection 28 and an end part of the outer peripheral surface of the mounting portion 17 on the side of the circuit board A. According to this configuration, even if the solder S in the molten state is in contact with the outer peripheral surface of the mounting portion 17 and the mounting surface of the first circuit board A, this solder S can be prevented from intruding into the gap between the inner peripheral surface of the first dielectric 25 and the outer peripheral surface of the mounting portion 17 by the capillary phenomenon.

The movable terminal 50 includes the movable-side dielectric 55 surrounding the movable-side inner conductor 51 and the movable-side outer conductor 58 surrounding the movable-side dielectric 55. An end part of the movable-side dielectric 55 on the side of the first terminal 15 projects further toward the first connecting portion 20 than an end part of the movable-side outer conductor 58. According to this configuration, when the movable terminal 50 is assembled with the first terminal 15, the interference of the movable-side outer conductor 58 with the first connecting portion 20 of the first inner conductor 16 can be prevented.

### Other Embodiments

The present invention is not limited by the above described and illustrated embodiment, but is represented by claims. The present invention is intended to include all changes in the scope of claims and in the meaning and scope of equivalents and also include the following embodiments.

Although the movable-side connecting portion is accommodated in the mounting-side connecting portion in the above embodiment, the mounting-side connecting portion may be accommodated in the movable-side connecting portion.

Although the mounting-side connecting portion resiliently contacts the movable-side connecting portion in the above embodiment, the movable-side connecting portion may resiliently contact the mounting-side connecting portion.

Although the movable-side dielectric projects further toward the mounting-side connecting portion than the movable-side outer conductor in the above embodiment, the movable-side outer conductor may project further toward the mounting-side connecting portion than the movable-side dielectric.

### LIST OF REFERENCE NUMERALS

A . . . first circuit board (circuit board)

B . . . second circuit board (circuit board)

Da . . . outer diameter of hollow cylindrical portion (mounting portion)

Db . . . outer diameter of supporting portion

Dc . . . outer diameter of body portion

De . . . outer diameter of movable-side connecting portion

S . . . solder

10 . . . first connector

11 . . . first housing (housing)

12 . . . first terminal accommodation chamber

15 . . . first terminal (mounting terminal)

16 . . . first inner conductor (mounting-side inner conductor)

17 . . . mounting portion (mounting-side connecting portion)

18 . . . hollow cylindrical portion

19 . . . leg portion

20 . . . first connecting portion

21 . . . supporting portion

22 . . . tapered portion

23 . . . resilient contact piece

24 . . . positioning protrusion

25 . . . first dielectric (mounting-side dielectric)

26 . . . center hole

27 . . . groove portion

28 . . . arcuate projection

29 . . . clearance

30 . . . first outer conductor

31 . . . resilient arm

32 . . . press-fit portion

33 . . . projecting portion

40 . . . second connector

41 . . . second housing

42 . . . terminal holding portion

43 . . . second terminal accommodation chamber

44 . . . guiding portion

45 . . . second terminal (mating terminal)

46 . . . second inner conductor

50 . . . movable terminal

51 . . . movable-side inner conductor

52 . . . body portion

53 . . . retaining projection

54 . . . movable-side connecting portion

55 . . . movable-side dielectric

56 . . . insertion hole

57 . . . accommodation recess

58 . . . movable-side outer conductor

59 . . . locking piece

60 . . . alignment member

61 . . . holding hole

1. A connector device, comprising:
a mounting terminal including a mounting-side inner conductor, the mounting terminal being mounted on a circuit board; and
an elongated movable terminal including a movable-side inner conductor, the movable terminal being arranged between the mounting terminal and a mating terminal,
the mounting-side inner conductor including:
a mounting portion to be connected to the circuit board; and
a mounting-side connecting portion extending from the mounting portion toward the movable terminal,
the movable-side inner conductor including:
a movable-side connecting portion to be connected to the mounting-side connecting portion while being fit to the mounting-side connecting portion in a length direction of the movable terminal; and
a shaft-like body portion extending from the movable-side connecting portion toward the mating terminal, and
an impedance near the circuit board and an impedance of a transmission path constituted by the movable terminal being matched by setting an outer diameter of the body portion and an outer diameter of the mounting portion equal.

2. The connector device of claim 1, wherein a length of the body portion is larger than that of the mounting-side inner conductor.

3. The connector device of claim 1, wherein:
the movable-side connecting portion is connected while being accommodated in the mounting-side connecting portion, and
an outer diameter of the movable-side connecting portion is set smaller than that of the body portion.

4. The connector device of claim 1, wherein:
the mounting portion is fixed to the circuit board by solder,
the mounting terminal includes a tubular mounting-side dielectric for accommodating the mounting-side inner conductor, and
a clearance is provided between an inner peripheral surface on an end part of the mounting-side dielectric on the side of the circuit board and an outer peripheral surface on an end part of the mounting portion on the side of the circuit board.

5. The connector device of claim 1, wherein:
the movable terminal includes a movable-side dielectric surrounding the movable-side inner conductor and a movable-side outer conductor surrounding the movable-side dielectric, and
an end part of the movable-side dielectric on the side of the mounting terminal projects further toward the mounting-side connecting portion than an end part of the movable-side outer conductor.
